(19) United States
(12) Patent Application Publication
(10) Pub. No.: US 2006/0092672 A1
(43) Pub. Date: May 4, 2006

(54) High-voltage generator and method of controlling high voltage

(75) Inventors: Jong-hwa Cho, Suwon-si (KR); Chul-woo Oh, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/266,261

(22) Filed: Nov. 4, 2005

(30) Foreign Application Priority Data
Nov. 4, 2004 (KR) 10-2004-0089386

(51) Int. Cl. H02M 3/335

(52) U.S. Cl. 363/21.01

(57) ABSTRACT

Disclosed is a high-voltage generator and method of controlling high voltage. The high-voltage generator includes: a power-supplying unit for rectifying an AC power supplied from the outside and generating a first and a second DC powers; a controlling unit to generate PWM (Pulse Width Modulated) signal with a predetermined duty-ratio when the first DC power is supplied; a comparing unit to compare the PWM (Pulse Width Modulated) signal and a predetermined reference voltage and to output a driving signal; a high-voltage generating unit to boost the second DC power by switching operation according to the driving signal and to generate high voltage; and a load sensing unit to sense a load supplied to an output end of the high-voltage generating unit. The controlling unit prevents a generation of high-voltage when the load is equal to, or less than a predetermined reference value. When the load is less than a reference value, the controlling unit restrains the PWM from inputting into the comparing unit, and forcibly prevents the generation of high voltage.

### CROSS-REFERENCE TO RELATED APPLICATION

This application claims benefit under 35 U.S.C. § 119(a) of Korean Patent Application No. 10-2004-0089386, filed Nov. 4, 2004, the entire contents of which are incorporated herein by reference.

### BACKGROUND OF THE INVENTION

1. Field of the Invention

The present invention relates to a high-voltage generator and method of controlling high voltage. More particularly, the present invention relates to a high-voltage generator and method of controlling high voltage, which senses an amount of load and prevents a generation of high voltage when determining the load to be equal to, or less than a predetermined reference value.

2. Description of the Related Art

In general, a high-voltage generator is used for electric equipment in need of high levels of Direct Current (DC) such as a laser printer, a laser replicator, and a facsimile machine (fax). The high-voltage generator converts DC into a high level of Alternating Current (AC) voltage, rectifies and then converts into a high DC voltage. The high-voltage generator generally has a transformer for converting DC voltage into AC voltage level.

FIG. 1 is a block diagram of a conventional high-voltage generator.

Referring to FIG. 1, the high-voltage generator includes a power supplying unit 10, a controlling unit 20, a comparing unit 30, a boosting unit 40, and a rectifying unit 50.

The power supplying unit 10 rectifies AC power applied from an external device (not shown), and generates DC power of 24V and 5V. 24V is an operating power of the boosting unit 40, and 5V is for the controlling unit 20.

The controlling unit 20 outputs PWM ((Pulse Width Modulated) signal) with a predetermined duty-ratio according to a predetermined value.

The comparing unit 30 includes an operational amplifier having a positive input end and a negative-input end. The input end is provided with PWM (Pulse Width Modulated signal) output from the controlling unit 20, while the negative-input end is input with Vref (Reference Voltage) which is obtained by distributing a 18 V by a distribution resistance Ra, Rb. The comparing unit 30 compares the PWM signal and the Vref.

The boosting unit 40 turns on or off an input end 41a of a transformer 41 by switching operation of a transistor 45, which is turned on or off according to comparing results of the comparing unit 30 and thus, boosts a 24 VDC power applied from the power-supplying unit 10 into hundreds to thousands of AC voltage. Since 24V of DC power is turned on or off in the input end 41a from time to time, it has the same effect as when AC voltage is supplied to the input end 41a of the transformer 41. Accordingly, there is high AC voltage induced at an output 41b end of the transformer 41.

The rectifying unit 50 rectifies high AC voltage output from the boosting unit 40, and converts high AC voltage into DC voltage and outputs DC voltage.

The high voltage generated at the high-voltage generator is used for forming image by toner moving in an image formation apparatus such as laser printer, laser replicator and fax. Rollers of a developing apparatus are the loads of the high-voltage generator.

However, in case of developing apparatus out of the image formation apparatus, there is no need to output high voltage. Instead, outputting high voltage due to abnormality may cause safety problems.

For example, high voltage must be stopped from being input, when a cover of the image formation apparatus is open. However, the cover of the image formation apparatus may open due to malfunction of a cover-opening switch or other abnormal situations, and in this case, a user may be injured from electric shocks by the high voltage input to the image formation apparatus. Also, in case of short circuit between high voltage supply and GND (Ground) under an abnormal situation, circuital damage may be brought to the image formation apparatus.

In order to prevent any possible electric shock accidents, it is regulated that electric current output can not exceed 2 mA when the high voltage is supplied to human resistance approximately of 2 KΩ. Since high-voltage output capacity should be reduced to satisfy such a regulation, it is required to modify development process condition.

Accordingly, there is a requirement for safety device, which can prevent output of the high voltage in case that the output end of the high-voltage apparatus comes into contact with human resistance or GND (Ground).

### SUMMARY OF THE INVENTION

Additional aspects and/or advantages of the invention will be set forth in part in the description which follows and, in part, will be apparent from the description, or may be learned by practice of the invention.

An aspect of the present invention is to solve at least the above problems and/or disadvantages and to provide at least the advantages described below. Accordingly, an aspect of the present invention is to provide a high-voltage generator and method of controlling high voltage, capable of preventing a generation of high voltage in case of determining the load to be equal to, or less than a predetermined reference value.

In order to achieve the above-described aspects of the present invention, there is provided the high-voltage generator including: a power-supplying unit to rectify an AC power supplied from an external device and generate a first and a second DC powers; a controlling unit to generate a PWM (Pulse Width Modulated) signal) with a predetermined duty-ratio when the first DC power is supplied; a comparing unit to compare the PWM (Pulse Width Modulated signal) and a predetermined reference voltage and to output a driving signal; a high-voltage generating unit to boost the second DC power by switching operation according to the driving signal and to generate high voltage; and a load sensing unit to sense a load supplied to an output end of the high-voltage generating unit. The controlling unit prevents a generation of high-voltage in case of the load equal to or less than a predetermined reference value. The controlling unit prevents high voltage from being generated in case of the load less than a predetermined value.

The high-voltage generator includes a high voltage output controlling unit for restraining high-voltage from being generated by blocking the PWM signal from being input into the comparing unit according to a control of the controlling unit.

The comparing unit is an operational amplifier having the PWM signal as a positive input and the reference voltage as a negative-input.

The load sensing unit senses as the load is supplied to the high-voltage generating unit and a load current flows, and converts the sensed result into a load detect potential signal, and the controlling unit outputs a control signal with a first logic level in case that the load resistance value corresponding to the load detect potential signal is equal to, or greater than a reference value, and outputs a control signal with a second logic level in case that the load resistance value corresponding to the load detect potential signal is less than a reference value.

The high-voltage output controlling unit prevents the PWM signal from being input into the comparing unit when the control signal with the second logic level is input.

The high-voltage output controlling unit is a transistor in which a base end is input with the control signal, one of a collector end and an emitter end is grounded, and the other of the collector end and the emitter end is connected to the positive input end of the comparing unit.

When receiving the control signal with the second logic level, the high-voltage output controlling unit turns the transistor on, such that a potential of the positive input end the operational amplifier is converted into zero.

A feedback resistor is connected between the comparing unit and the output end of the high-voltage generating unit, to feed back an output voltage.

The high-voltage generating unit includes a boosting unit to boost the second DC power into the high-voltage AC voltage by switching operation according to the driving signal and a rectifying unit to rectify the high AC voltage into a DC voltage.

In order to achieve the above-described aspects of the present invention, there is provided a method of controlling high voltage including: rectifying the AC power supplied form the outside and generating a first and a second DC powers, generating a PWM (Pulse Width Modulated) signal with a predetermined duty-ratio when the first DC power is supplied; generating high voltage according to the PWM; sensing the load for high voltage supply; and preventing the generation of high voltage by restraining the PWM signal from being input when the load is equal to, or less than the reference value.

Here, the sensing operation the load includes sensing the load current flowing as the high voltage is supplied to the load, converting into the load detect signal and recognizing the load resistance value corresponding to the load detect signal.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional high-voltage generator;

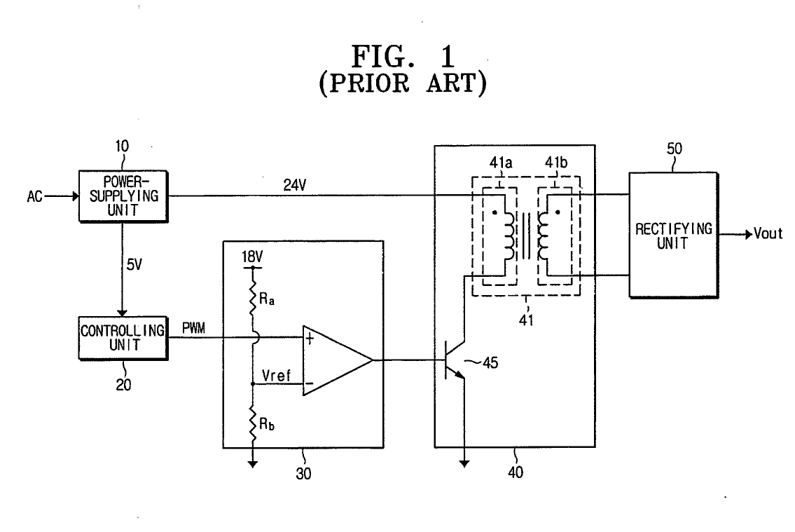

FIG. 2 is a block diagram of a high-voltage generator according to an embodiment of the present invention; and

FIG. 3 shows a flow chart of a method of controlling high voltage according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

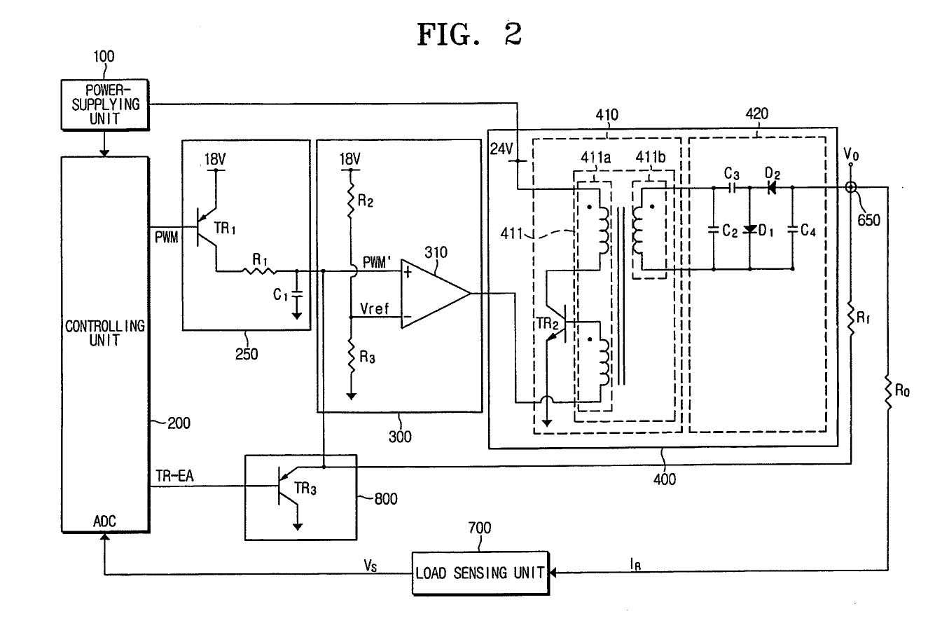

FIG. 2 is a block diagram of a high-voltage generator according to an embodiment of the present invention.

Referring to FIG. 2, the high-voltage generator includes a power supplying unit 100, a controlling unit 200, an inputting unit 250, a comparing unit 300, a high-voltage generating unit 400, a load sensing unit 700, and a high-voltage output controlling unit 800. The high-voltage generating unit 400 includes a boosting unit 410 and a rectifying unit 420.

The power-supplying unit 100 rectifies an AC power supplied from an external device (not shown), to generate 24V and 5V of DC power, respectively. 24V is an operating power of the boosting unit 410, and 5V is an operating power of the controlling unit 200.

The inputting unit 250 converts a PWM (Pulse Width Modulated) signal into a PWM′ signal to have a predetermined DC level, through a transistor TR1 and RC low-pass filters R1, C1.

The comparing unit 300 includes an operational amplifier 310 with a positive input end (+) and a negative-input end (−). The PWM′signal is converted at the inputting unit 250 to a predetermined DC level and is supplied to the positive input end of the operational amplifier 310. 18V is divided by resistance R2, R3, to be input to the negative input end of the operational amplifier 310. At this time, the divided voltage is called as a reference voltage, Vref. The comparing unit 300 compares the PWM signal and Vref, and outputs a driving signal to drive transistor TR2 of the boosting unit 410.

In order to stabilize an operation of the operational amplifier 310, an output voltage Vo of the high-voltage generating unit 300 is fed back to the positive input end of the operational amplifier 310 through a feedback resistance Rf. The output voltage has a negative voltage. On the contrary, the output voltage with a positive value is input to the negative-input end of the operational amplifier 310.

The high-voltage generating unit 400 outputs hundreds through thousands of voltages according to the driving signal output by the comparing unit 300.

The boosting unit 410 turns on or off an input end 411a of a transformer 411 according to switching of the transistor TR2 having on or off mode depending on the output driving signal from the comparing unit 300. 24V of DC power supplied at the power-supplying unit 100 is boosted to hundreds through thousands of AC.

In the input end 411a of the transformer 411, 24V of DC frequently turns on or off by the driving signal. Therefore, it has the same effect as when an AC is supplied to the input end 411a of the transformer 411. Accordingly, high AC voltage is induced to the output end 411b of the transformer 411.

The rectifying unit 420 rectifies high AC output from the boosting unit 410 into high DC by capacitors C2, C3, C4 and diodes D1, D2 and outputs through an output end 650 of the high-voltage generating unit 400.

When load Ro is supplied to the output end 650 of the high-voltage generating unit 400 and a load current IR flows, the load sensing unit 700 senses the load current IR, converts into a load detect potential signals, and outputs to the controlling unit 200.

The controlling unit 200 outputs the PWM (Pulse Width Modulated) signal having a predetermined duty-ratio according to a predetermined value and recognizes a load resistance value corresponding to the load-potential signal Vs input from the load sensing unit 700. When the load-resistance value is higher than a reference value, a control signal TR-EA with logic “HIGH” is output, to make a transistor TR3 off. On the contrary, when the load resistance value is lower than a reference value, a control signal TR-EA with logic “LOW” is output, to make a transistor TR3 on.

The above setting is easily realized by providing microprocessor (not shown) as the controlling unit 200, which stores a reference table with the resistance value corresponding to respective potential signals Vs input from the load sensing unit 700 at a memory device, and programs in such a manner that the controlling unit 200 recognizes load resistance value by converting the load-potential signal Vs input into an Analog to Digital Converter (ADC) port into digital signal and comparing the converted load-potential signal with respect to the table. In this setting, if the load resistance value is lower than a reference value, a control signal TR-EA with logic “LOW” is output.

Generally, the reference value may be set as a minimum load resistance value as measured, with a developing apparatus being mounted. The reference value can be changed according to needs.

When control signal with a second logic level is input to the controlling unit 200, the transistor TR3 is turned on, and the high-voltage output controlling unit 800 makes potential of positive input end of the operational amplifier 310 to be zero. Accordingly, a PWM signal output from the controlling unit 200 is prevented from being input to the comparing unit 300, such that high-voltage is not output any more.

The transistor TR3 is PNP type. An emitter end is connected to the positive input end of the operational amplifier 310, a base end is input with a control signal TR-EA of the controlling unit 200, and a collector end is grounded. Accordingly, when the “LOW” signal is input into the reference end from the controlling unit 200, the transistor TR3 is on, such that potential of positive input end of the operational amplifier 310 becomes zero.

In one embodiment of the present invention, it has been illustrated that the PNP-type of transistor is employed for the high-voltage output controlling unit 800 by way of example. However, other components may be adapted for switching operation such that PWM can be prevented from being input into the comparing unit 300 according to the control signal TR-EA from the controlling unit 200.

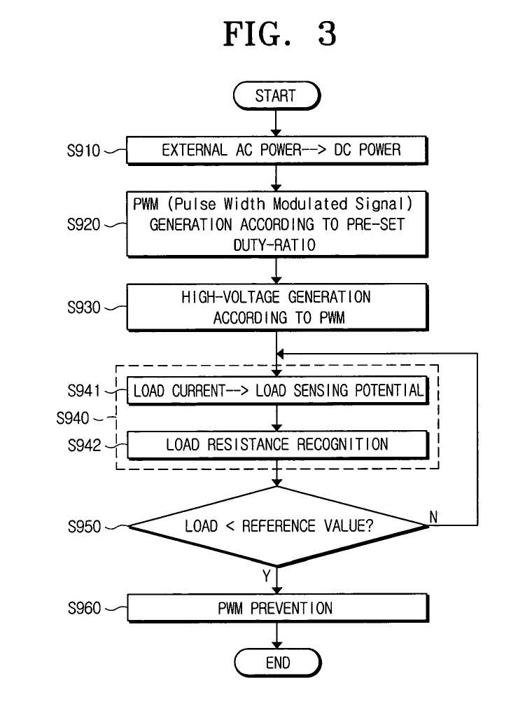

FIG. 3 shows a flow chart of a method of controlling high voltage according to an embodiment of the present invention.

Referring to FIGS. 2 and 3, first of all, AC supplied from an external device (not shown) is rectified at the power-supplying unit 100, to generate predetermined DC power (for example, 24V, 5V) (S910).

With the DC supplied from the power-supplying unit 100, the controlling unit 200 generates a PMW signal with the predetermined duty-ratio. The newly generated PMW signal is output to the positive input end of the comparing unit 310, through the inputting unit 250. Then, the controlling unit 200 outputs the control signal TR-EA of logic “HIGH” to the high-voltage output controlling unit 800 (S920). Since the transistor TR3 is turned off with the control signal TR-EA of logic “HIGH” input, the high-voltage output controlling unit 800 does not affect the boosting operation of the high-voltage generating unit 400.

Next, the comparing unit 310 compares the PWM′ signal and the predetermined reference voltage, to output the driving signal. The high-voltage generating unit 400 boosts the DC input from the power-supplying unit 100 by the switching operation according to the driving signal. Therefore, the high-voltage generating unit 400 generates high voltage in proportion to the duty-ratio of PWM (S930) signal.

Next, the controlling unit 200 senses through the load sensing unit 700, the load supplied to the output end 650 of the high-voltage generating unit 400 (S940).

Next, when the load Ro is supplied to the output end 650 of the high-voltage generating unit 400 and the load current (I_{R}) flows, the load sensing unit 700 senses the load current IR, converts into the load detect potential signal Vs and outputs to the controlling unit 200 (S941). Next, the controlling unit 200 recognizes the load-resistance value corresponding to the load-potential signal Vs input from the load sensing unit 700 (S942).

The controlling unit 200 compares the load resistance value and the reference value. When the load resistance value equals to, or less than the reference level, the controlling unit 200 converts the logic level of the control signal TR-EA into logic “LOW” and outputs the result. On the contrary, the logic level of the control signal TR-EA is changed to logic “HIGH” when the load resistance value greater than the reference level (S950).

If the control signal TR-EA of logic “LOW” is input, the transistor TR3 is on, thereby making the potential of the positive input end to be zero, to prevent the PWM′ signal from being input into the comparing unit 310 (S960). Therefore, high voltage is not generated any more.

As described above, according to an embodiment of the present invention, in case of malfunction of a cover-opening switch or other abnormal situations, and the high voltage input to the image formation apparatus with the cover of the image formation apparatus open, a PWM signal input into the comparing part is blocked when the load equals to, or less than the reference value, such that the high voltage is prevented from being generated.

Further, according to an embodiment of the present invention, it is effective in terms of preventing electric shock, because it does not require lowering high-voltage output capacity nor changing conditions on process, to satisfy a safety rule that the output current should not exceed 2 mA in case of high-voltage supply to human resistance (approximately 2 KΩ).

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A high-voltage generator comprising:
a power-supplying unit rectify an AC power supplied from an external device and to generate a first and a second DC powers;
a controlling unit to generate PWM (Pulse Width Modulated Signal) with a predetermined duty-ratio when the first DC power is supplied;
a comparing unit to compare the PWM (Pulse Width Modulated Signal) and a predetermined reference voltage and to output a driving signal;
a high-voltage generating unit to boost the second DC power by switching operation according to the driving signal and to generate a high voltage; and
a load sensing unit to sense a load supplied to an output end of the high-voltage generating unit,
wherein the controlling unit prevents the high voltage from being generated in case of the load less than a predetermined value.

2. The high-voltage generator of claim 1, comprising:
a high-voltage output controlling unit to restrain a high voltage from being generated by blocking the PWM from being input into the comparing unit according to a control of the controlling unit.

3. The high-voltage generator of claim 1, wherein the comparing unit is an operational amplifier having the PWM as a positive input and the reference voltage as a negative-input.

4. The high-voltage generator of claim 2, wherein the load sensing unit senses as the load is supplied to the high-voltage generating unit and a load current flows, and converts the sensed result into a load detect potential signal, and
the controlling unit outputs a control signal with a first logic level in case that the load resistance value corresponding to the load detect potential signal is equal to, or greater than a reference value, and outputs a control signal with a second logic level in case that the load resistance value corresponding to the load detect potential signal is less than a reference value.

5. The high-voltage generator of claim 3, wherein the high-voltage output controlling unit prevents the PWM from being input into the comparing unit when the control signal with the second logic level is input.

6. The high-voltage generator of claim 4, wherein the high-voltage output controlling unit is a transistor in which a base end is input with the control signal, one of a collector end and an emitter end is grounded, and the other of the collector end and the emitter end is connected to the positive input end of the comparing unit.

7. The high-voltage generator of claim 4, when receiving the control signal with the second logic level, the high-voltage output controlling unit turns the transistor on, such that a potential of the positive input end the operational amplifier is converted into zero.

8. The high-voltage generator of claim 1, wherein a feedback resistance is connected between the comparing unit and the output end of the high-voltage generating unit, to feed back an output voltage.

9. The high-voltage generator of claim 1, wherein the high-voltage generating unit comprises:
a boosting unit for boosting the second DC power into the high-voltage AC voltage by switching operation according to the driving signal; and
a rectifying unit for rectifying the high AC voltage into a DC voltage.

10. The high-voltage generator of claim 1, further comprising an output current is not exceed about 2 mA in case of high voltage supply to a human resistance.

11. The high-voltage generator of claim 1, further comprising a memory device to store the reference signal.

12. A method of controlling high voltage comprising:
rectifying the AC power supplied from an external device and generating a first and a second DC powers;
generating a PWM (Phase Width Modulated) signal with a predetermined duty-ratio when the first DC power is supplied;
generating a high voltage according to the PWM signal;
sensing the load for high voltage supply; and
preventing the generation of the high voltage by restraining the PWM signal from being input when the load is equal to, or less than a reference value.

13. The high-voltage generator of claim 10, wherein sensing the load operation comprises:
sensing the load current flowing as the high voltage is supplied to the load, and converting into the load detect potential signal; and
recognizing the load resistance value corresponding to the load detect potential signal.
